(19) United States
(12) Patent Application Publication
(10) Pub. No.: US 2012/0157898 A1
(43) Pub. Date: Jun. 21, 2012

(54) MASSAGER

(75) Inventors: Tomohiko Watanabe, Shiga (JP); Koji Terada, Shiga (JP); Akihiro Takaya, Shiga (JP); Taichi Hamatsuka, Shiga (JP); Yoshimi Takahashi, Shiga (JP)

(73) Assignee: PANASONIC CORPORATION, Osaka (JP)

(21) Appl. No.: 13/393,971

(22) PCT Filed: Sep. 24, 2010
(86) PCT No.: PCT/JP2010/005758

§ 371 Date: Mar. 2, 2012

(30) Foreign Application Priority Data
Sep. 25, 2009 (JP) 2009-221615

(51) Int. Cl. A61H 9/00

(52) U.S. Cl. 601/148

(57) ABSTRACT

Provided is a massager which enables armrests to be used effectively even with a backrest in a reclined state. The massager includes: a backrest having a massaging mechanism for massaging the back of a user; a frame which supports the backrest in such a manner that the backrest can be reclined backwards; a pair of armrests which extend forward respectively from left and right side positions of the backrest; and a linking mechanism which changes an attitude of the pair of armrests in conjunction with a reclining operation of the backrest, in such a manner that a rear part of each armrest falls lower than the front part of each armrest, when the backrest is reclined backward.

### TECHNICAL FIELD

The present invention relates to a massager, and in particular to a chair-type massager.

### BACKGROUND ART

A massager is known which comprises a backrest in which a massage mechanism for massaging the back of a user is provided, and armrests which respectively extend forwards from positions on the left and right-hand sides of the backrest (see, for example, Patent Document 1). This massager relaxes a user who is sitting with his or her arms resting on the armrests.

The backrest provided with the massager described above is normally reclinable, with the object of enhancing the massaging effect and allowing the body to relax.

However, in the massager, in a state where the backrest is upright, the user can rest his or her arms on the armrests, but if the backrest is tilted backwards to a reclined position, then the armrests cannot be used effectively. More specifically, in the massager described above, since the armrests are located in the same position, irrespective of the recline position of the backrest, then if the backrest is in a reclined state, the distance from the reclined backrest to the armrests becomes longer and in practical terms, only an end of the user's hands can reach the armrests. Therefore, it is not possible to use the armrests when in the reclined position.
Patent Document 1: Japanese Patent Application Publication No. 2005-192603

### SUMMARY OF THE INVENTION

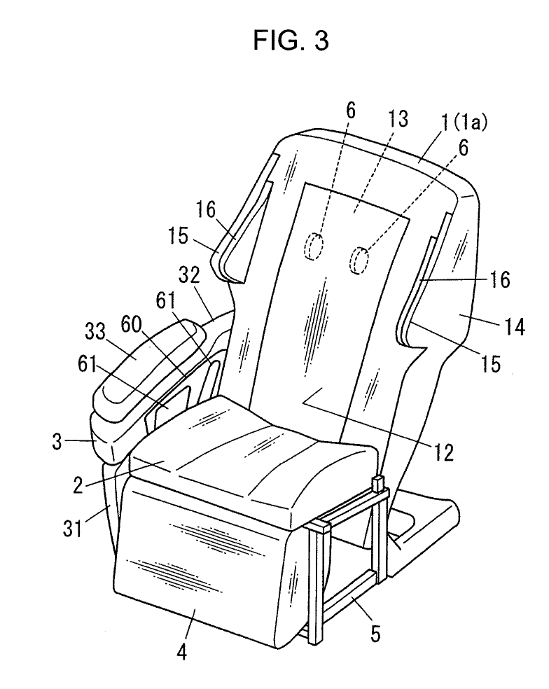

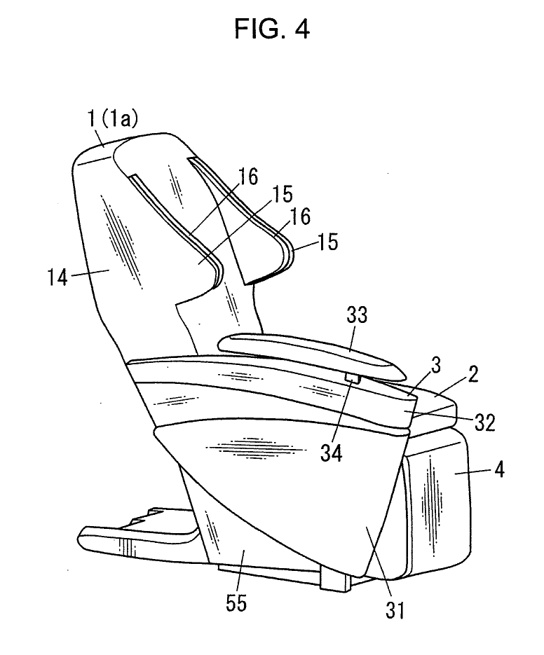

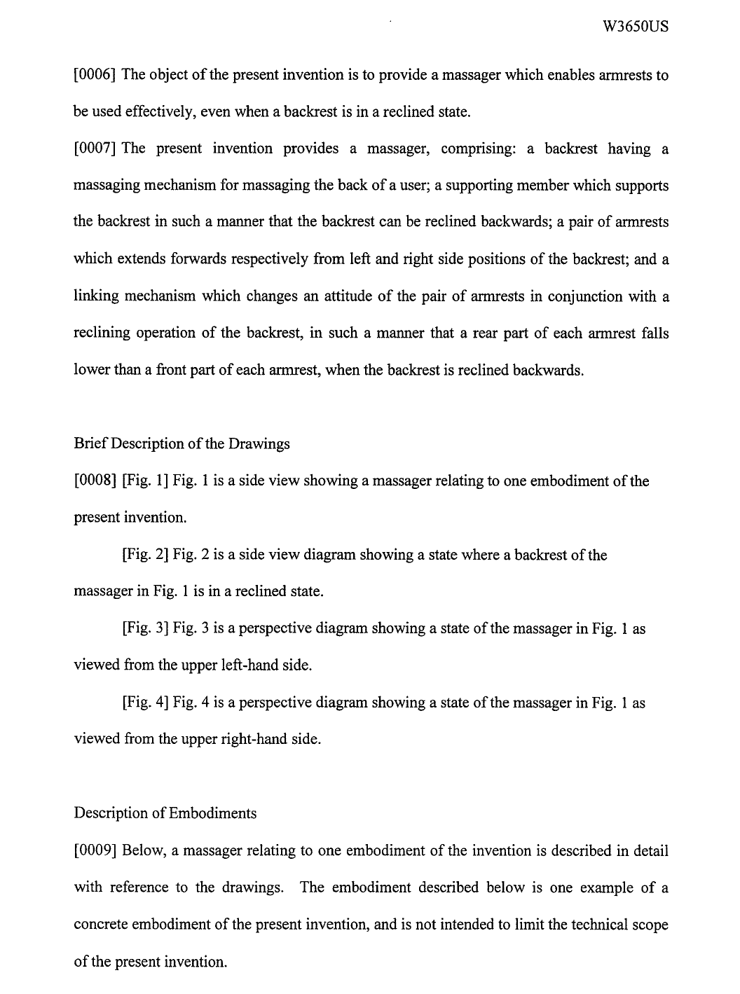

As shown in FIG. 3 and FIG. 4, the chair-type massager relating to the present embodiment comprises a backrest 1 having a built-in massaging mechanism (not illustrated) for massaging a user's back, a frame (supporting member) 5 which supports the backrest in such a manner that the backrest 1 can be reclined in the backward direction, a seat 2 provided on the frame 5, a pair of armrests 3, provided on the left and right-hand sides of the seat 2 (the left-hand armrest 3 is omitted from the drawings), and a footrest 4 which is provided below the front edge of the seat 2. The footrest 4 is supported axially on the upper part of the front edge of the frame 5, so as to be rotatable about a horizontal axis. More specifically, the footrest 4 can be rotated between the position shown in FIG. 3 and FIG. 4 where the surface for resting the user's feet is facing forwards, to a position where the surface for resting the user's feet is situated in a substantially horizontal state at a position in front of the seat 2.

Moreover, the massager also comprises a unit (not illustrated) for driving rotation of the footrest 4, a lift unit 51 for performing a reclining operation of the backrest 1, an air pump and valve (not illustrated) for supplying air to air bags, which are described below, and a frame cover 55 which covers the outer side of the frame 5. The unit for driving rotation of the footrest 4 and the lift unit 51, the air pump and the valve are respective disposed inside the frame 5.

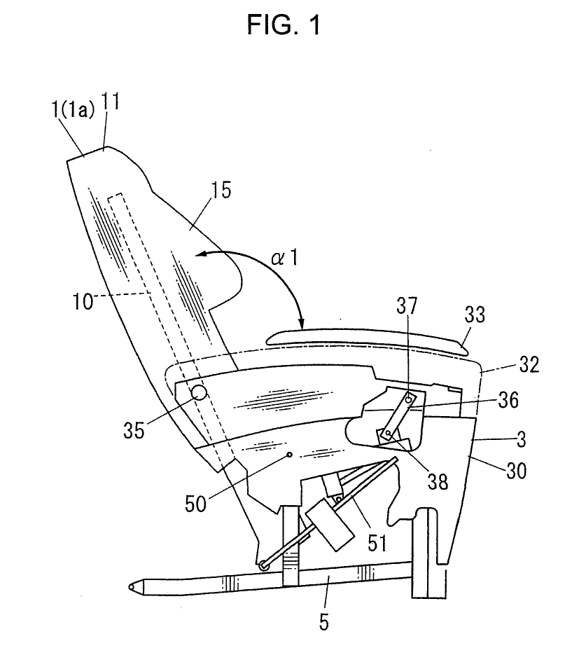

As shown in FIG. 1, the lower part of the backrest 1 is supported by a shaft 50 which extends in the left/right direction with respect to the upper rear end of the frame 5, so as to be rotatable in the forward/backward direction about the shaft 50. In other words, the backrest 1 is linked rotatably to the frame 5 by the shaft 50. Furthermore, the lift unit 51 is provided between the lower end of the backrest 1 and the upper front end of the frame 5, and the backrest 1 is rotated with respect to the frame 5 about the shaft 50 by extension and contraction of this lift unit 51.

More specifically, the backrest 1 comprises a backrest frame 10 having a frame shape, a box-shaped frame 11 which covers the backrest frame 10, an outer cover 12 which covers the box-shaped frame 11, and a massaging mechanism having a treatment element 6 which is provided inside the outer cover 12. The treatment element 6 is provided inside an opening 13 which is provided on the front surface of the box-shaped frame 11, so as to be movable vertically along the backrest frame 10. Massaging of the back of the user is performed by bringing the treatment element 6 into contact with the user's back via the outer cover 12.

The armrests 3 each respectively comprise a side plate 30 which is disposed to the side of the seat 2, a side cover 31 which covers the outer surface of the side plate 30, an armrest section 32 which covers the upper surface of the side plate 30, and an armrest cover 33 provided over the armrest section 32. The armrest cover 33 is attached on the armrest section 32 in such a manner that a gap is formed between the lower surface of the armrest cover 33 and the upper surface of the armrest section 32. More specifically, an attachment member 34 for attaching the armrest cover 33 on the armrest section 32 is provided between the lower surface of the front end portion of the armrest cover 33 and the upper surface of the armrest section 32. Moreover, an air bag (not illustrated) is provided on the lower surface of the armrest cover 33 (in other words, on the surface opposing the armrest section 32). By repeating expansion and contraction of the air bag, it is possible to massage the user's arm which is inserted between the upper surface of the armrest section 32 and the armrest cover 33.

The massager relating to the present embodiment comprises a linking mechanism which changes the attitude of the pair of armrests 3 in conjunction with the reclining operation of the backrest 1, in such a manner that the rear part of each armrest 3 falls lower than the front part of each armrest 3 when the backrest 1 is reclined backwards. The linking mechanism comprises the rear part of each armrest 3 which are respectively coupled to the backrest 1 (backrest frame 10), the front part of each armrest 3, links (coupling members) 36 which are coupled to the front parts of the respective armrests 3, the front part of the frame 5 which is coupled to the links 36, shafts 35, shafts 37 and shafts 38.

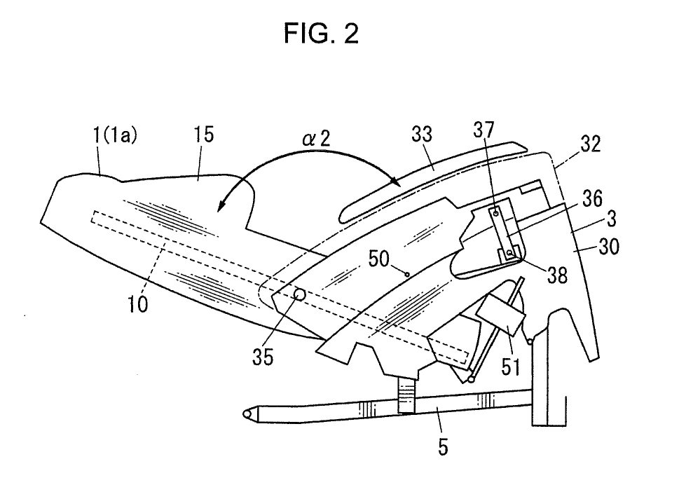

More specifically, as shown in FIG. 1 and FIG. 2, the rear end part of the side plate 30 of each armrest 3 is coupled by a shaft 35 to the backrest 1 (the backrest frame 10), and the front end part of the side plate 30 of each armrest 3 is coupled to the frame 5 via a link 36. The link 36 has a first end which is coupled rotatably with respect to the side plate 30 by a shaft 37, and a second end which is coupled rotatably with respect to the frame 5 by a shaft 38. In this way, the rear parts of the armrests 3 are coupled to the backrest 1 and the front parts of the armrests 3 are coupled to the frame 5 via the links 36, whereby the angle of the upper surface of each armrest 3 is tilted backwards and downwards by means of the armrest 3 rotating about the shaft 50 in synchronism with the reclining operation of the backrest 1. More specifically, the linking mechanism changes the attitude of the armrests 3 in such a manner that the rear part of each armrest 3 falls lower than the front part of the armrest 3 as the backrest 1 is reclined backwards. Moreover, since the front parts of the armrests 3 are coupled to the frame 5 via the links 36, then the front parts of the armrests 3 are allowed to rise until a prescribed upper position which is specified by the radius of rotation of the links 36 which rotate about the shafts 38 (the distance between the shaft 37 and the shaft 38), and the rising of the front parts of the armrests 3 is restricted at a prescribed raising position. The length of the links 36 is shorter than the distance between the shafts 35 and the shaft 50. Consequently, when the backrest 1 is in a fully reclined state, it is possible to keep the upper surface of the armrests 3 in a horizontal attitude, while shortening the distance between the backrest 1 and the rear parts of the armrests 3. In other words, in the present embodiment, the amount of change in the angle of the upper surfaces of the armrests 3 with respect to the frame 5 is made smaller than the amount of change in the angle of the backrest 1 with respect to the frame 5. More specifically, in the state shown in FIG. 1 where the backrest 1 is upright, the angle α1 formed between the front surface of the backrest 1 and the upper surfaces of the armrests 3 is 115 degrees. On the other hand, in the state shown in FIG. 2 where the backrest 1 is reclined furthest, the angle α2 formed between the front surface of the backrest 1 and the upper surfaces of the armrests 3 is 160 degrees.

In the massager relating to the present embodiment, in contrast to a massager in which the armrests are fixed and only the backrest can be reclined, it is possible to keep the upper surfaces of the armrests 3 in a horizontal attitude while shortening the distance between the backrest 1 and the armrests 3, when the backrest 1 is in a reclined state. Therefore, the user is able to rest his or her arms on the armrests 3 in a relaxed state, even when the backrest 1 is reclined. Since the armrests 3 can be used with the backrest 1 in a reclined state in this way, then it is possible to carry out a massage of the user's arms (including wrists and hands) by means of the air bags in the armrests 3.

The massager also comprises side plates 60 which are fixed to the frame 5 and which are provided along the inner surfaces (the surfaces on the seat 2 side) of the armrests 3, and air bags 61 which are provided on the inner surfaces (the surfaces on the seat 2 side) of these side plates 60. The side plates 60 are provided respectively between the seat 2 and the respective armrests 3, and are fixed to the frame 5 so as not to be displaced with respect to the seat 2, irrespective of the reclining operation of the backrest 1. By repeating expansion and contraction of the air bags 61, it is possible to massage the side of the user's hips and thighs, or alternatively, by expanding the air bags 61, it is possible to fix the sides of the user's hips and thighs with respect to the massager.

Moreover, the backrest 1 relating to the present embodiment comprises a backrest main body 1a for receiving the back of the user, a pair of extending sections 14 which respectively extend sideways from the left and right sides of the upper part of the backrest main body 1a, and a pair of side walls 15 which respectively project forwards from the left and right edges of the front surfaces of the extending sections 14. The backrest 1 further comprises a pair of air bags 16 which are respectively provided on the inner side faces of the side walls 15. The side walls 15 are not attached on the side faces of the backrest 1, but rather project forwards from the front surfaces of the extending sections 14.

The extending sections 14 each have an upper edge portion which connects smoothly with the upper end of the back rest main body 1a, and have a shape whereby the amount of sideways extension becomes progressively larger in the downward direction. The side walls 15 are respectively provided along the side edges of the extending sections 14, and therefore have inclined surfaces which match the side faces of the extending sections 14. Moreover, the amount of forward projection of the side walls 15 from the backrest main body 1a is zero at the upper edge of the backrest 1 and becomes greater, in the downward direction. Consequently, the side walls 15 create an outer appearance which is unified with the backrest main body 1a. Furthermore, the air bags 16 provided respectively on the inner surfaces of the side walls 15 have a triangular shape which becomes larger toward the lower side, similarly to the respective side walls 15.

In this massager, it is possible to massage the sides of the user, from the shoulders to the upper arms, by repeating expansion and contraction of the air bags 16 which are disposed on the inner side of the side walls 15 of the backrest 1, with the user sitting on the seat 2 with his or her back resting against the backrest 1. Furthermore, by fixing the user to the backrest 1 by expanding the air bags 16, it is possible to prevent the user from rising up from the backrest 1 when the massage mechanism provided inside the backrest 1 pushes the treatment element against the user from behind. Consequently, it is possible to apply a massage to the back of the user, more effectively.

Moreover, since the inner side surfaces of each side wall 15 are arranged in a downward broadening fashion in such a manner that they become further distanced from each other in the downward direction, as described above, and since the air bags 16 are provided along the inner side surfaces of each side wall 15, then it is possible reliably to press the inclined surfaces of the user's sides from the shoulders to the upper arms by means of the expanded air bags 16. In particular, since the air bags 16 have properties whereby the wide portion thereof swells greatly, then the lower part of each air bag 16 swells to a large size compared to the upper part, and pressure points on the upper surfaces of the user's upper arms can be massaged effectively by the air bags 16. Moreover, if the height at which the user is seated is varied slightly, then it is possible to prevent the occurrence of problems such as the application of too strong a pressing force, or too weak a pressing force.

The extending sections 14 are provided only on the upper part of the backrest 1, and the side walls 15 are also provided in the range where the extending sections 14 are formed. Therefore, when the backrest 1 is reclined, it is possible to prevent the extending sections 14 or the side walls 15 from interfering with the user's arms which are resting on the armrests 3. Moreover, although the respective extending sections 14 extend sideways from the side faces of the backrest main body 1a, these extending sections 14 do not project sideways beyond the armrests 3 provided on either side of the seat 2, and hence it is possible to avoid increase in the size of the massager when packaged.

The side walls 15 are designed in such a manner that, when the backrest 1 is reclined furthest backwards, the side walls assume positions which are higher than the front surface of the backrest main body 1a (the surface which receives the back of the user), but remain within a height range substantially the same as or lower than the height position of the distal end portion of the backrest main body 1a, and therefore in this respect also, it is possible to avoid increase in the size of the massager when packaged.

In the embodiment described above, a massager is described in which the front parts of the respective armrests 3 are raised in accordance with a reclining operation of the backrest 1, but the front parts of the armrests 3 do not necessarily have to be raised. For instance, it is also possible to lower the rear parts of the armrests 3, while causing the front parts of the armrests 3 to slide backwards without rising, in accordance with a reclining operation.

Moreover, in the aforementioned embodiment, a massager is described in which the front parts of the armrests 3 and the frame 5 are coupled via links 36, but the invention is not limited to this. For instance, it is also possible to couple the front parts of the armrests 3 and the frame 5 in a relatively displaceable fashion by means of rails and sliders which can slide along the rails.

The concrete embodiments described above principally include an invention having the following composition.

The massager relating to the present embodiment comprises: a backrest having a massaging mechanism for massaging the back of a user; a supporting member which supports the backrest in such a manner that the backrest can be reclined backwards; a pair of armrests which extend forwards respectively from left and right side positions of the backrest; and a linking mechanism which changes an attitude of the pair of armrests in conjunction with a reclining operation of the backrest, in such a manner that a rear part of each armrest falls lower than a front part of each armrest, when the backrest is reclined backwards.

According to the massager relating to the present embodiment, since the rear parts of the armrests fall lower than the front parts of the armrests in conjunction with a reclining operation which tilts the backrest backwards, it is possible to prevent the rear parts of the armrests from becoming distanced from the backrest when the backrest is in a reclined state. Consequently, when the backrest is in a reclined state, the user is able to relax with his or her arms resting on the armrests. In particular, in a massager having a massaging member for massaging the arms of a user provided on the upper surfaces of the armrests, it is possible to massage the user's arms with the backrest in a reclined state.

In the massager described above, desirably, an amount of change in an angle of the armrests caused in conjunction with the reclining operation of the backrest is smaller than an amount of change in an angle of the backrest in the reclining operation of the backrest.

By making the change in the angle of the armrests with respect to the supporting member which is linked to a reclining operation of the backrest smaller than the change in the angle of the backrest with respect to the supporting member caused by the reclining operation of the backrest, it is possible to maintain the armrests in a horizontal attitude, to a certain extent, and therefore the user can rest his or her arms on the armrests in a relaxed state.

In the massager described above, desirably, the linking mechanism includes the rear parts of the armrests which are coupled respectively to the backrest.

By coupling the rear parts of the armrests to the backrest, it is possible to lower the rear parts of the armrests in conjunction with the reclining operation of the backrest.

In the massager described above, desirably, the rear parts of the armrests are respectively coupled to the backrest in such a manner that the front parts of the armrests rise up in conjunction with the reclining operation of the backrest.

In so doing, it is possible to raise the front parts of the armrests and to lower the rear parts of the armrests in conjunction with the reclining operation.

In the massager described above, desirably, the linking mechanism has coupling members which respectively couple the front parts of the armrests with the supporting member, so as to allow the front parts of the armrests to rise up to a prescribed raised position, while restricting the front parts of the armrests from rising up beyond the prescribed raised position.

In so doing, it is possible to restrict the height of the front parts of the armrests which rise up in accordance with the reclining operation, to a prescribed height position. Consequently, the armrests can be maintained in a horizontal attitude to a certain extent, even when the backrest is reclined, and therefore the user is able to rest his or her arms on the armrests in a relaxed state.

In the massager described above, desirably, the linking mechanism has supporting shafts which respectively connect the rear parts of the armrests with the backrest so as to be rotatable about an axis parallel to a rotating shaft of the reclining operation of the backrest; and each of the coupling members is formed of a link having a first end which is rotatable with respect to the front part of the armrest about an axis parallel to the supporting shaft and a second end which is rotatable with respect to the supporting member about an axis parallel to the supporting shaft.

By means of this composition, by respectively coupling the front parts of the armrests and the supporting member by links, it is possible to achieve a linking mechanism between the backrest and the armrests, in a simple fashion.

Desirably, the massager described above further comprises: a seat for the user to sit on; and a pair of armrest inside sections which are disposed respectively between the seat and the armrests and which are not displaced with respect to the seat, irrespective of the reclining operation of the backrest.

By providing a pair of armrest inside sections to the inside of the armrests, these armrest inside sections not being displaced with respect to the seat irrespective of the reclining operation of the backrest, then it is possible to restrict the occurrence of situations where the user's arm, or the like, becomes trapped in the gap between the armrest and the seat, which move relatively with respect to each other.

In the massager described above, desirably, the pair of armrest inside sections respectively include massaging members for massaging the sides of a hip region of a user, the massaging members being provided respectively between the armrest inside sections and the seat.

By providing massaging members for massaging the sides of a user's hip region, on the inner sides of the armrests, it is possible to massage the sides of the user's hip region even when the backrest is in a reclined state, irrespective of the movement of the armrests in conjunction with the reclining operation of the backrest.

### INDUSTRIAL APPLICABILITY

According to the present embodiment, since the rear parts of the armrests fall lower than the front parts of the armrests in conjunction with a reclining operation which tilts the backrest backwards, it is possible to prevent the rear parts of the armrests from becoming distanced from the backrest when the backrest is in a reclined state. Consequently, when the backrest is in a reclined state, the user is able to relax with his or her arms resting on the armrests. In particular, in a massager having a massaging member for massaging the arms of a user provided on the upper surfaces of the armrests, it is possible to massage the user's arms with the backrest in a reclined state.

### DESCRIPTION OF THE SYMBOLS

1 backrest
2 seat
3 armrest
5 frame (example of supporting member)
35 shaft
36 link
50 shaft (example of rotating shaft)
60 side plate (example of armrest inside section)
61 air bag (example of massaging member)

1. A massager, comprising:
a backrest having a massaging mechanism for massaging the back of a user;
a supporting member which supports the backrest in such a manner that the backrest can be reclined backwards;
a pair of armrests which extend forwards respectively from left and right side positions of the backrest; and
a linking mechanism which changes an attitude of the pair of armrests in conjunction with a reclining operation of the backrest, in such a manner that a rear part of each armrest falls lower than a front part of each armrest, when the backrest is reclined backwards.

2. The massager according to claim 1, wherein an amount of change in an angle of the armrests caused in conjunction with the reclining operation of the backrest is smaller than an amount of change in an angle of the backrest in the reclining operation of the backrest.

3. The massager according to claim 1, wherein the linking mechanism includes the rear parts of the armrests which are coupled respectively to the backrest.

4. The massager according to claim 3, wherein the rear parts of the armrests are respectively coupled to the backrest in such a manner that the front parts of the armrests rise up in conjunction with the reclining operation of the backrest.

5. The massager according to claim 4, wherein the linking mechanism has coupling members which respectively couple the front parts of the armrests with the supporting member, so as to allow the front parts of the armrests to rise up to a prescribed raised position, while restricting the front parts of the armrests from rising up beyond the prescribed raised position.

6. The massager according to claim 5, wherein the linking mechanism has supporting shafts which respectively connect the rear parts of the armrests with the backrest so as to be rotatable about an axis parallel to a rotating shaft of the reclining operation of the backrest, and
each of the coupling members is formed of a link having a first end which is rotatable with respect to the front part of the armrest about an axis parallel to the supporting shaft and a second end which is rotatable with respect to the supporting member about an axis parallel to the supporting shaft.

7. The massager according to claim 1, further comprising:
a seat for the user to sit on; and
a pair of armrest inside sections which are disposed respectively between the seat and the armrests and which are not displaced with respect to the seat, irrespective of the reclining operation of the backrest.

8. The massager according to claim 7, wherein the pair of armrest inside sections respectively include massaging members for massaging the sides of a hip region of a user, the massaging members being provided respectively between the armrest inside sections and the seat.
